(19) United States
(12) Patent Application Publication
(10) Pub. No.: US 2001/0006143 A1
(43) Pub. Date: Jul. 5, 2001

(54) Switching device

(76) Inventor: Takeshi Sato, Chitose (JP)

Correspondence Address: WENDEROTH, LIND & PONACK, L.L.P., 2033 K Street, N.W., Suite 800, Washington, DC, 20006, US

(21) Appl. No.: 09/749,757

(22) Filed: Dec. 28, 2000

(30) Foreign Application Priority Data
Dec. 28, 1999 (JP) 11-373244

(51) Int. Cl. H01H 25/04

(52) U.S. Cl. 200/6 A

(57) ABSTRACT

To provide a switching device for selecting an operational instruction and deciding the operational instruction and a portable terminal device having the same switching device capable of preventing a malfunction of the switching device. The switching device comprises a decision switch 4, selection switches 5a, 5b, a key base 6, a guide 9, a key top 12 and the like, and it is constituted in that the pressure on central portion of the key top is transmitted to the decision switch through the key base and the force of tilting the key top toward a center axis is transmitted to the selection switches through the guide and the key base. Additionally to this structure, an interstice is provided between the key top and the guide, the decision switch is formed by a domed switch of more layers than the selection switch, an interstice is provided between the decision switch and the key base, and through holes 8a, 8b are provided in the key base respectively between the portion corresponding to the upper portion of decision switch and the respective portions corresponding to the upper portions of the selection switches.

### BACKGROUND OF THE INVENTION

1. Field of the Invention

The present invention relates to a switching device for selecting an operative instruction and deciding the operational instruction, and more particularly to a switching device decreased in malfunctions.

2. Description of the Related Art

For example, in a portable telephone system, key operation becomes disadvantageously complicated with recent progress of soft function, and moreover density of keys in accordance with downsizing of the body as well as miniaturization of the key itself further make the operation complicated. In order to cope with this problem, various techniques of a switch have been progressed, such as a switch in a combination of a function key and a ten-key, using a jog dial, using a cross key, and using a stick switch.

For example, in the case of using a stick switch, one key operation enables a shift of a cursor for retrieving an operational instruction and executing the retrieved operational instruction, thereby improving the operational performance remarkably compared with the case of beating a ten-key many times. In the structure of separately mounting a stick switch (for example, a purchase), however, since the volume for the body of the stick switch itself and the area for soldering it are required, in advancing downsizing and thinning of the portable telephone system itself, the size of a stick switch may be disadvantageously limited and a malfunction may occur at ease.

In place of this stick switch, for example, Japanese Patent Application Laid-Open Publication No. 11-126126 discloses a scroll switch device for a portable telephone comprising a decision switch for deciding an operational instruction to a portable telephone and a plurality of selection switches of shifting a cursor on an information display. This scroll switch device, however, is not enough yet from the viewpoint of preventing a malfunction.

As mentioned in the above conventional example, even a scroll switch device having much more possibility of downsizing than a stick switch is defective in preventing a malfunction. Therefore, a switch capable of surely preventing a malfunction is extremely desired.

### SUMMARY OF THE INVENTION

In order to solve the above conventional problem, the present invention aims to provide a switching device decreased in the possibility of a malfunction occurring when selecting an operational instruction by a selection switch and deciding the operational instruction by a decision switch.

In order to achieve the above object, a switching device according to the present invention comprises a decision switch for deciding an operational instruction, a selection switch disposed around the decision switch for selecting an operational instruction, a key top whose central portion is disposed over the decision switch, and a guide disposed around the key top, and it is constituted in that the pressure on central portion of the key top is transmitted to the decision switch, while the force of tilting the key top toward a center axis is transmitted to the selection switch through the guide, and especially that the key top and the guide are separately formed with an interstice provided therebetween.

Accordingly, since the interstice is provided between the key top and the guide, the pressure on the central portion of the key can be prevented from being transmitted to the selection switch when the same pressure is to be transmitted to the decision switch, for example, even when the key top is a little tilted, thereby preventing from such a malfunction that the selection switch is also operated at the operation of the decision switch.

A switching device according to the present invention comprises a decision switch for deciding an operational instruction, a selection switch disposed around the decision switch for selecting an operational instruction, and a key top whose central portion is disposed over the decision switch, and it is constituted in that the pressure on the central portion of the key top is transmitted to the decision switch, the force of tilting the key top toward a center axis is transmitted to the selection switch, the decision switch and the selection switch are formed by a domed switch for switching through conducting electricity between isolated conductive terminals by the pressure on a curved protruded elastic material, and that the decision switch is formed by the domed switch of more layers than the selection switch.

Accordingly, since the decision switch is formed by the domed switch of more layers than the selection switch, the decision switch becomes difficult to be pushed down compared with the selection switch. Therefore, even if the force in the downward direction (that is, in the direction of the decision switch) may be produced when the force of tilting the key top toward the center axis is transmitted to the selection switch, the decision switch can be prevented from going down. In the other words, it can prevent from such a malfunction that the decision switch also goes down when the selection switch is pressed.

Additionally to the above structure, a switching device according to the present invention further comprises a key base disposed between the both switches (namely, the decision switch and the selection switch) and the key top, and it is constituted in that the pressure on the central portion of the key top is transmitted to the decision switch through the key base, the force of tilting the key top toward the center axis is transmitted to the selection switch through the key base, and that a through hole is provided in the key base between the portion corresponding to the upper portion of the decision switch and the portion corresponding to the upper portion of the selection switch, thereby making this portion softer than the other portions.

Accordingly, since the portion of the key base between the portion corresponding to the upper portion of the decision switch and the portion corresponding to the upper portion of the selection switch is formed softly compared with the other portions, the pressure on the central portion of the key top becomes difficult to be transmitted to the selection switch and the force of tilting the key top toward the center axis becomes difficult to be transmitted to the decision switch, thereby preventing from such a malfunction that the other is also operated at the operation of one of the decision switch and the selection switch.

A switching device according to the present invention comprises a decision switch for deciding an operational instruction, a selection switch disposed around the decision switch for selecting an operational instruction, a key top whose central portion is disposed over the decision switch, and a key base disposed between the both switches (namely, the decision switch and the selection switch) and the key top, and it is constituted in that the pressure on the central portion of the key top is transmitted to the decision switch through the key base, the force of tilting the key top toward a center axis is transmitted to the selection switch through the key base, and that the selection switch and the key base are adjacently provided, while an interstice is provided between the decision switch and the key base.

Accordingly, since the selection switch and the key base are adjacently provided and an interstice is provided between the decision switch and the key base, the decision switch becomes more difficult to be operated than the selection switch, thereby preventing from such a malfunction that the decision switch is also operated at the operation of the selection switch.

Additionally to the above structure, a switching device according to the present invention is constituted in that the portion of the key base between the portion corresponding to the upper portion of the decision switch and the portion corresponding the upper portion of the selection switch is formed softly compared with the other portions. Especially, a switching device according to the present invention is preferably constituted in that a through hole is provided in the key base between the portion corresponding to the upper portion of the decision switch and the portion corresponding to the upper portion of the selection switch, thereby making this portion softer than the other portions.

Accordingly, since the portion of the key base between the portion corresponding to the upper portion of the decision switch and the portion corresponding to the upper portion of the selection switch is formed softly compared with the other portions, the pressure on the central portion of the key top becomes difficult to be transmitted to the selection switch and the force of tilting the key top toward the center axis becomes difficult to be transmitted to the decision switch, thereby preventing from such a malfunction that the other is also operated at the operation of one of the decision switch and the selection switch.

Additionally to the above structure, a switching device of the present invention is constituted in that the decision switch and the selection switch are formed on a key sheet and the same key sheet and that the key base are integrally formed with the key sheet and the key base of each ten-key.

Accordingly, since the both switches (namely, the decision switch and the selection switch) and the ten-key use the key sheet and the key base in common, thereby realizing the reduction in the number of the parts and the cost and realizing downsizing and thinning of the switching device.

Further, a portable terminal device provided with one of the above-mentioned various switches can be formed.

The portable terminal device provided with a switching device capable of selecting an operational instruction and deciding an operational instruction, as mentioned above, can prevent from a malfunction at the operation of the switching device.

### BRIEF DESCRIPTION OF THE DRAWINGS

FIG. 1 is a top view of a scroll switch device provided in a portable telephone system in accordance with one embodiment of the present invention.

FIG. 2 is a sectional view taken along the line X-X of the scroll switch device and its vicinity provided in the portable telephone system relative to the embodiment of the present invention.

FIG. 3 is an enlarged view of the portion A.

FIG. 4 is a sectional view of the scroll switch device and its vicinity when the key top is pressed.

FIG. 5 is a sectional view of the scroll switch device and its vicinity when the key top is a little tilted.

FIG. 6 is a sectional view of the scroll switch device and its vicinity when the key top is tilted.

FIG. 7 is a sectional view of the scroll switch device and its vicinity when the key top is tilted.

### DETAILED DESCRIPTION OF THE PREFERRED EMBODIMENTS

A preferred embodiment of the present invention will be described with reference to the drawings.

In this embodiment, the structure and the operation of a scroll switch device that is an example of the switching device concerned to the present invention will be fully described together with the description of the structure and the operation of a portable telephone system that is an example of a portable terminal concerned to the present invention.

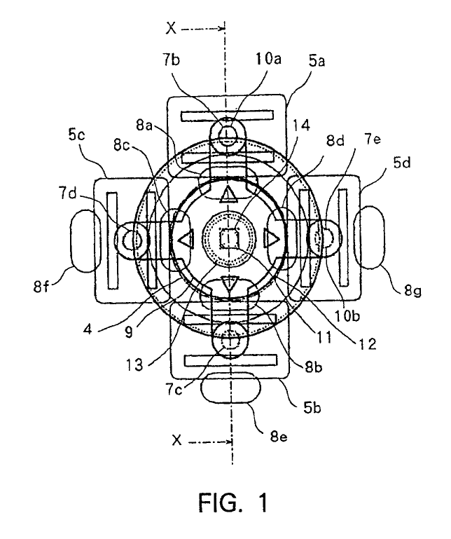

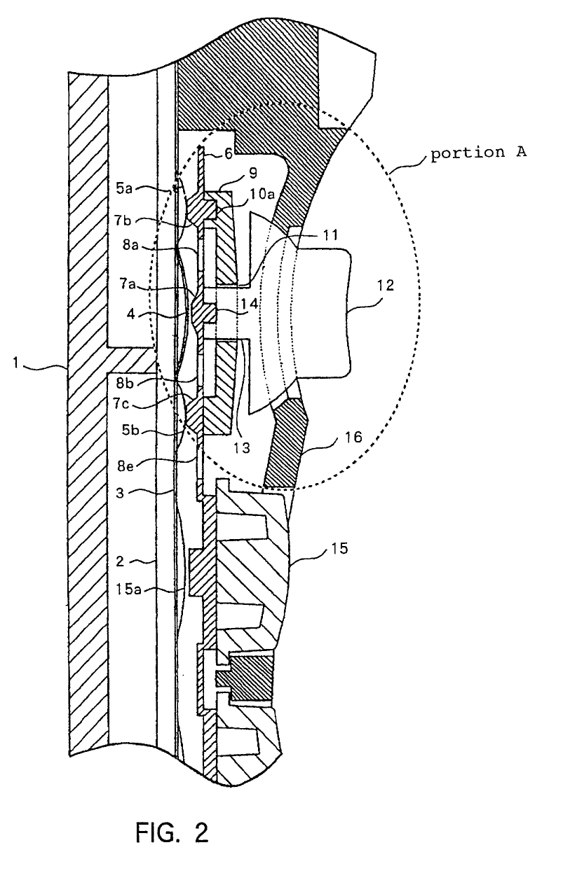

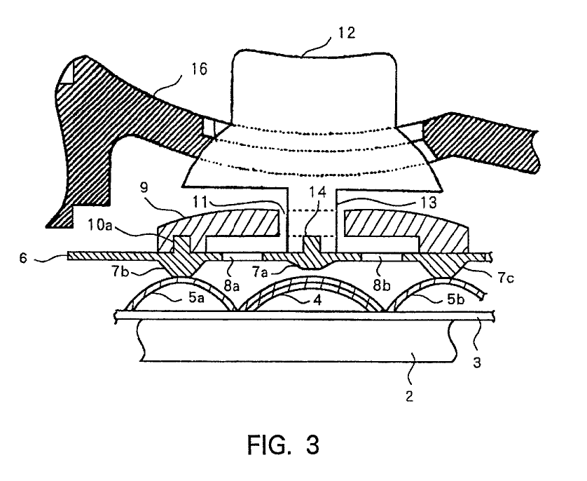

FIG. 1 is a plan view of a scroll switch device provided in the portable telephone system of this embodiment, FIG. 2 is a sectional view taken along the line X-X of the scroll switch device and its vicinity provided in the portable telephone system of this embodiment, and FIG. 3 is an enlarged view of the A portion indicated by a dotted line in FIG. 2. In these figures, the same reference numerals are attached to the same components.

With reference to FIGS. 1 to 3, the structure of the portable telephone system of this embodiment and the structure of the scroll switch device of this embodiment provided in the same portable telephone system will be described.

The portable telephone system of this embodiment is formed by covering a circuit (not illustrated) having a wireless communication function, a scroll switch device, a ten-key 15, an information display (not illustrated) and the like with a casing, and for example, a casing 1 on the rear side and a casing 16 on the front side are shown in FIG. 2.

On the upper portion of the casing 1 on the rear side, a print board 2 is supported by a projected portion of the casing 1, and the scroll switch device of this embodiment is provided on the print board 2. Here, the upper portion means the front side.

More specifically, for example, a thin key sheet 3 made of PET sheet is provided on the print board 2, one decision switch 4 formed in a domed shape is stuck on the key sheet 3 and four selection switches 5a to 5d formed similarly in a domed shape are stuck there.

Here, the four selection switches 5a to 5d are positioned at regular intervals in a shape of a cross around the decision switch 4, and the respective selection switches 5a to 5d have a function of selecting an operational instruction, while moving a cursor displayed on the information display such as a liquid crystal display screen provided on the portable telephone system of the embodiment, in the respective inherent direction.

The decision switch 4 has a function of deciding the operational instruction selected by the above-mentioned cursor so to make the portable telephone system execute the same operation.

As an operating method of these switches 4, 5a to 5d, for example, one of the selection switches 5a to 5d is turned on, so to move the cursor to select one of various operational instructions toward the portable telephone system and turned off, and the decision switch 4 is turned on, thereby to decide the same operational instruction.

The domed switch is formed by two isolated conductive terminals (conductive pattern) provided on an elastic material formed in a curved shape and the print board 2, and a conductive portion provided on the elastic material, by way of example. It is constituted in that the pressure toward the elastic material bents and deforms the elastic material, so to put the conductive portion of the elastic material into contact with the two conductive terminals, hence to conduct electricity between the two conductive terminals, thereby turning on (or off) the switch, and that the elastic material is returned to the original curved shape, hence to electrically isolate the two conductive terminals again, thereby turning off (or on) the switch. In the embodiment, a metal is used as the elastic material, and the domed switch is formed by a domed metal click plate.

In the embodiment, for example, as illustrated in FIG. 3, the respective selection switches 5a to 5d are formed by one layered domed switch, and the decision switch 4 is formed by overlaying two layers of the same domed switch that forms the respective selection switches 5a to 5d.

A key base 6 formed by a rubber such as a soft rubber is provided on the upper portion of the decision switch 4 and the selection switches 5a to 5d. The key base 6 is provided with a conical convex portion 7a opposite to the central portion of the decision switch 4, four conical convex portions 7b to 7e opposite to the respective central portions of the respective selection switches 5a to 5d, and four through holes 8a to 8d positioned respectively between the opposite portion of the decision switch 4 and the opposite portions opposite to the respective selection switches 5a to 5d. A predetermined interstice is provided between the decision switch 4 and the convex portion 7a opposite to it, and the respective selection switches 5a to 5d are provided in contact with the convex portions 7b to 7e opposite to the respective ones. These convex portions 7a to 7e are designed to directly press the switches 4, 5a to 5d opposite to the respective portions by pushing the key base 6 downward.

A guide 9 formed by, for example, a mold and a key top 12 formed by, for example, a mold or a hard rubber are independently provided on the upper portion of the key base 6.

As illustrated in FIG. 1, the guide 9 is in a shape of a cross, the central portion thereof is positioned at the upper portion corresponding to the central portion of the decision switch 4, and four ribs are extended therefrom toward the respective selection switches 5a to 5d like a cross.

These four ribs adhere to the key base 6 to be integrally fixed there at the upper portions opposite to the respective central portions of the respective selection switches 5a to 5d. Cylindrical concave/convex portions 10a and 10b for mutually positioning the guide 9 and the key base 6 are provided in one of thus fixed plural positions (in this embodiment, two of the four positions). The respective concave/convex portions 10a and 10b are formed by engaging the concave portion formed in one of the guide 9 and the key base 6 with the convex portion formed on the other. In this embodiment, the convex portion is provided on the key base 6, while the concave portion is provided on the guide 9.

A cylindrical hole 11 for putting through a boss 13 of the key top 12 described later is provided in the central portion of the guide 9. For example, as illustrated in FIG. 3, a predetermined interstice is provided between the guide 9 and the boss 13 of the key top 12. The guide 9 is positioned around the key top 12 having this interstice, providing a function for transmitting to the key base 6, the power when the peripheral portion of the key top 12 is inclined toward the center axis so as to press the guide 9.

The central portion of the key top 12 is positioned at the upper portion opposite to the central portion of the decision switch 4, the cylindrical boss 13 with the central portion regarded as an axis is protruded toward the decision switch 4 in the central portion of the key top 12, and the end portion of the boss 13 adheres to the key base 6 and it is integrally fixed there. A quadrangular concave/convex portion 14 for mutually positioning the key top 12 and the key base 6 and mutually stopping rotation is provided in the fixed portion.

The concave/convex portion 14 is formed by engaging the concave portion formed in one of the key base 6 and the boss 13 of the key top 12 and with the convex portion formed in the other. In this embodiment, the quadrangular convex portion is provided in the key base 6 and the concave portion corresponding to this quadrangle is provided in the boss 13 of the key top 12. Further, the concave/convex portion may be formed in a polygonal shape, an ellipse shape, or the like so as to stop the rotation of the key top 12 if only it has a shape other than the cylindrical one.

In the embodiment, the key sheet 3 and the key base 6 of the scroll switch device is integrally formed with the key sheet and the key base of each ten-key switch. More specifically, a domed switch 15a for a ten-key is also provided on the key sheet 3 of the embodiment, and the ten-key 15 is provided on the key base 6 at the opposite position of the central portion of the domed switch 15a. Further, through holes 8e to 8g having the same function as the above-mentioned through holes 8a to 8d are provided in the key base 6 of the embodiment respectively between the upper portions opposite to the respective selection switches 5b to 5d and the upper portion opposite to each domed switch (ten-key switch) 15a of each ten-key 15.

The casing 16 on the front side is formed so as to expose the top of the key top 12 which is operated by a user, the top of the ten-key 15 which is operated by a user, and the information display seen by a user to the outward of the front side and to accommodate the key top 12, the ten-key 15, and the information display into the inside thereof. More specifically, a skirt portion formed in the key top 12 and a protruded portion formed in the ten-key are lodged in the casing 16 on the front side so as not to go out from the inside of the casing 16.

In the scroll switch device provided in the portable telephone system of the embodiment constituted in the above, a user operates the peripheral portion of the key top 12 so to tilt the key top 12 toward the center axis. Therefore, the tilt force is transmitted to one of the selection switches 5a to 5d through the guide 9 and the key base 6, so to press the same selection switch of 5a to 5d. Then, a cursor on the information display is shifted in the direction corresponding to the pressed selection switch of 5a to 5d, where an operational instruction can be selected. Further, a user operates the central portion of the key top 12 so to press the central portion of the key top 12, the pressure is transmitted to the decision switch 4 through the key base 6, so to press the decision switch 4, thereby deciding the operational instruction selected by a cursor.

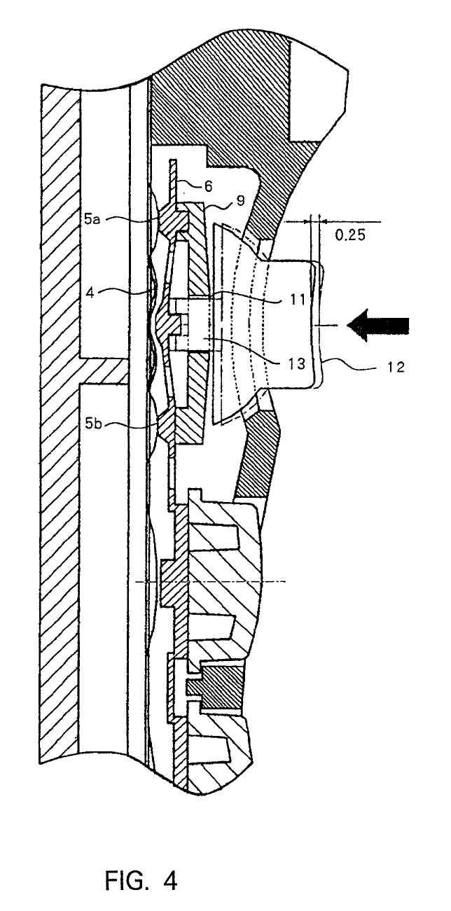

Some operational states of the scroll switch device of the embodiment provided in the portable telephone system of the embodiment will be described with reference to FIGS. 4 to 7.

FIG. 4 shows a sectional example of the scroll switch device and its vicinity according to the embodiment in the state where the central portion of the key top 12 is 0.25 mm pressed down. In this state, the decision switch 4 is pressed and deformed through the key base 6 by pressing down the key top 12, thereby performing the deciding operation of the operational instruction. Here, since the decision switch 4 of the embodiment is formed by overlaying two metal domed switches so as to get a stronger force of inversion, the decision switch 4 would not operate unless a user presses the central portion of the key top 12 on purpose.

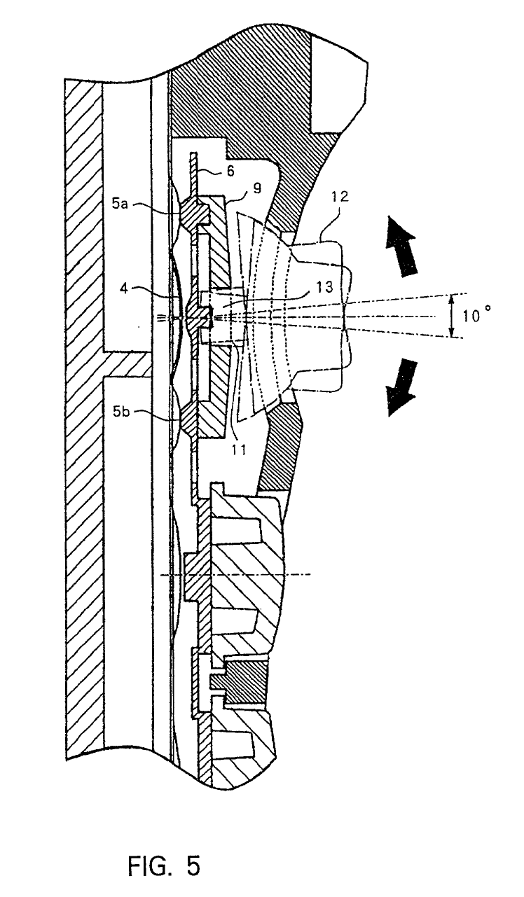

FIG. 5 shows a sectional example of the scroll switch device and its vicinity according to the embodiment in the state where the key top 12 is a little tilted vertically (for example, ±5° and the less) toward the center axis (similarly in right and left). In this embodiment, since the predetermined interstice is provided between the boss 13 of the key top 12 and the through hole 11 of the guide 9, the tilt force is not directly transmitted to the guide 9 even in the state as shown in this figure, thereby preventing the selection switches 5a to 5d from easily going down.

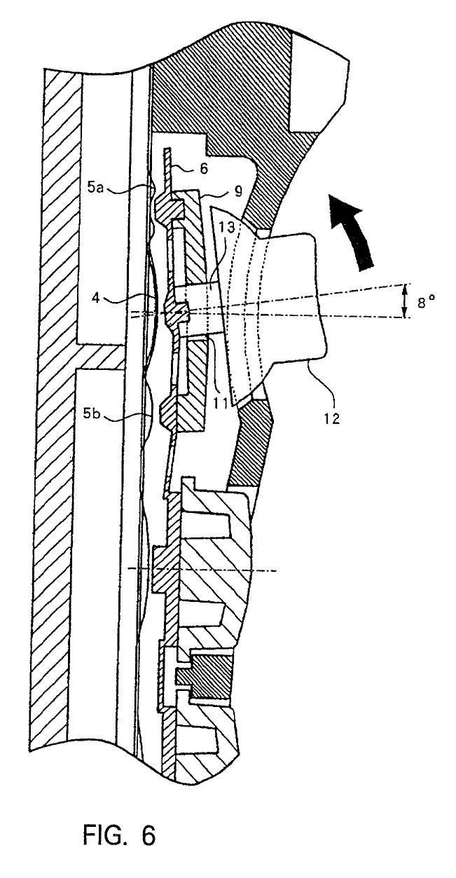

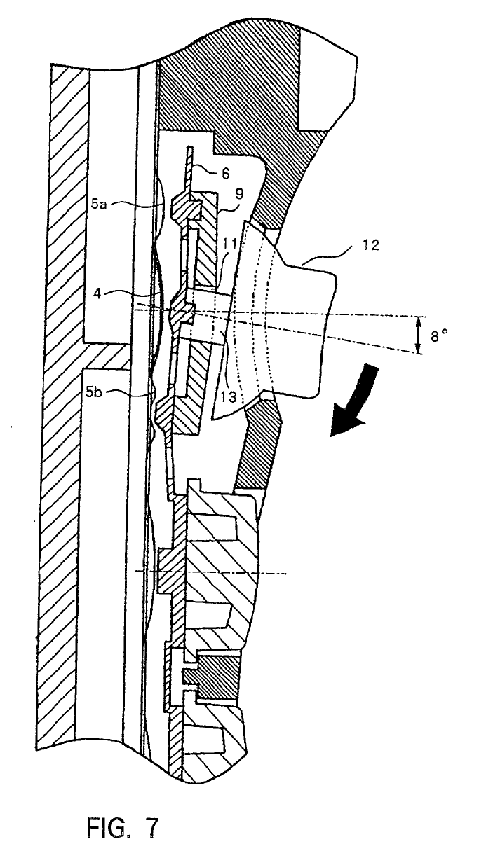

FIGS. 6 and 7 show each sectional example of the scroll switch device and its vicinity according to the embodiment in the state where the key top 12 is further tilted (in this example, ±8° and so) compared with the case as shown in FIG. 5. In this state, the boss 13 of the key top 12 is adjacent to the through hole 11 of the guide 9 so to press the guide 9 to tilt. Therefore, the selection switch of 5a to 5d corresponding to the direction of this tilt is pressed down, thereby selecting an operational instruction (for example, scroll operation).

As mentioned above, the scroll switch device of the embodiment provided in the portable telephone system of the embodiment can perform the operation of both the decision switch 4 and the selection switches 5a to 5d which are provided separately, by one key (key top 12), thereby decreasing the number of the operation keys. A user can get a necessary function (various functions provided in the portable telephone system) at ease only by one key operation (key top 12) according to the instruction while looking at the information display.

Further, in the scroll switch device of the embodiment provided in the portable telephone system of the embodiment, since the key top 12 and the guide 9 are separately constituted and the predetermined interstice is provided between the key top 12 and the guide 9, force is not easily transmitted to the guide 9, within a predetermined range, only by a little tilt of the key top 12, such as when the key top 12 is pressed down, a little touched and a little tilted, thereby preventing from a malfunction of the selection switches 5a to 5d. In the other words, only when a user tilts the key top 12 on purpose to try to operate the selection switches 5a to 5d, the selection switches 5a to 5d will operate. As the size of this interstice, various sizes may be considered as far as it can prevent from the above malfunction.

Further, in the scroll switch device of the embodiment provided in the portable telephone system of the embodiment, since the respective selection switches 5a to 5d are formed by one layered domed click plate and the decision switch 4 is formed overlaying two layers of the same click plate as the above, the load against deformation by the pressure of the decision switch 4 becomes much more than the selection switches 5a to 5d around it, thereby preventing a malfunction from easily occurring in the decision switch 4 at the operation of the selection switches 5a to 5d. As a method of increasing the load against deformation on the domed switch, for example, generally the diameter of the dome is increased. However, this method is not suitable for downsizing, but the structure of the embodiment is more preferable.

In the scroll switch-device of the embodiment provided in the portable telephone system of the embodiment, since the convex portions 7b to 7e of the key base 6 are into contact with the respective selection switches 5a to 5d and the convex portion 7a of the key base 6 is isolated from the decision switch 4 with a predetermined interstice, it is possible to prevent a malfunction from easily occurring in the decision switch 4 when the selection switches 5a to 5d are operated. As the size of this interstice, various sizes may be considered as far as it can prevent from the above malfunction.

In the scroll switch device of the embodiment provided in the portable telephone system of the embodiment, the through holes 8a to 8d are provided in the portions respectively between the portion corresponding to the upper portion of the decision switch 4 and the portions corresponding to the upper portions of the respective selection switches 5a to 5d, of the portion forming the key base 6, and these portions are formed in softer than the other portions. Therefore, when the key top 12 is pressed so to operate the decision switch 4 and when the key top 12 is tilted so to operate the selection switches 5a to 5d, it is possible to decrease the degree of transmitting the force to each other between the decision switch 4 and the respective selection switches 5a to 5d through the key base 6, and also it is possible to relieve the load resistance of the key base 6 itself, thereby enabling the assured and smooth operation of the respective switches 4, 5a to 5d.

Since the distance between the decision switch 4 and the respective selection switches 5a to 5d and the mutual distance between the selection switches 5a to 5d become very small, with the advance of miniaturization of a scroll switch device, there arises a problem of interaction between the respective switches 4, 5a to 5d caused by the resistance of the key base 6 in pressing down and tilting the key top 12. In the structure of the embodiment, however, since the force is dispersed by the through holes 8a to 8d provided between the respective switches 4, 5a to 5d, in order to solve the problem, it is possible to prevent from a malfunction of the decision switch 4 and the selection switches 5a to 5d. As the size of this through hole, various sizes may be considered if only it can prevent from the malfunction.

If the whole key base is made soft, the portion corresponding to the upper portion of the decision switch 4 and the portions corresponding to the upper portions of the selection switches 5a to 5d become soft, and the switching operation may work poorly. Use of the above structure of the embodiment, however, can harden the portion corresponding to the upper portion of the decision switch 4 of the key base 6 and the portions corresponding to the upper portions of the selection switches 5a to 5d to some degree and make it difficult to transmit the force to the other switch at a time of pushing one of the decision switch 4 and the selection switches 5a to 5d.

In the scroll switch device of the embodiment provided in the portable telephone system of the embodiment, since the key sheet and the key base of the scroll switch device is formed integrally with the key sheet and the key base of the ten-key 15, not separately, the number of the parts and the cost can be decreased, thereby realizing further downsizing and thinning of the scroll switch device.

In the scroll switch device of the embodiment provided in the portable telephone system of the embodiment, since the key base 6, the guide 9, and the key top 12 are integrally formed in their relative position, it is possible to realize the assured operation of the respective central portions of the domed switches respectively forming the decision switch 4 and the selection switches 5a to 5d, by the key top 12.

The structure of the switching device and the portable terminal relative to the present invention is not restricted to the above-mentioned structure, but various structures may be used.

As one example, although in the embodiment, the four selection switches 5a to 5d are provided around the decision switch 4 in a shape of a cross at regular intervals, various structures may be used as for the number of the selection switches and the arrangement thereof.

Though the embodiment is constituted in that an interstice is provided between the key top 12 and the guide 9, the key top 12 and the guide 9 may be separately put into contact with each other in a slidable way. In this slidable structure, even when the key top 12 is pressed down to operate the decision switch 4, a malfunction of the selection switches 5a to 5d can be prevented because the pressure is not transmitted to the guide 9. More specifically, the force of pressing down the central portion of the key top 12 is not transmitted to the selection switches 5a to 5d, while it is transmitted to the decision switch 4, thereby preventing from such a malfunction that the selection switches 5a to 5d are operated by mistake at the operation of the decision switch 4.

Though the domed switch is formed by a metal elastic material in the embodiment, an elastic rubber or a spring may be used as the elastic material, if only it can be deformed by a force and returned to the original shape by removing the force. Further, the domed switch is not restricted to the structure shown in the embodiment, but various structures may be used if only it can be switched on and off by pressing the curved protruded portion.

Though the selection switches 5a to 5d are formed by one-layered domed switch and the decision switch 4 is formed by two-layered domed switch in the embodiment, another structure is possible as far as the decision switch can be formed stronger by overlapping much more layers of the domed switches, than the selection switches.

Though the through holes 8a to 8d are provided respectively between the portion corresponding to the upper portion of the decision switch 4 of the key base 6 and the portions corresponding to the upper portions of the respective selection switches 5a to 5d (hereinafter, referred to as the portion B), thereby making these portions softer than the other portions, in the embodiment, it is also possible to make the portion B softer than the other portions by forming only the portion B of the key base 6 by the soft material, or forming only the portion B thin.

Though the embodiment has been described in the case where the portable terminal relative to the present invention is adopted to the portable telephone system, the portable terminal system relative to the present invention may be adopted to various portable terminal systems such as a PHS as far as it can do the selecting processing of an operational instruction and the deciding processing of the operational instruction.

The selecting processing of an operational instruction and the deciding processing of the operational instruction performed by the switching device relative to the present invention and the portable terminal relative to the present invention may be controlled by a processor running a control program stored in a ROM, in a hardware resource provided with, for example, a processor or a memory, or they may be arranged as a hardware circuit of each independent function for executing the respective processing.

As set forth hereinabove, the switching device of the present invention comprises a decision switch for deciding an operational instruction, a selection switch disposed around the decision switch for selecting an operational instruction, a key top whose central portion is disposed over the decision switch, and a guide disposed around the key top, and it is constituted in that the pressure on the central portion of the key top is transmitted to the decision switch, the force of tilting the key top toward a center axis is transmitted to the selection switch through the guide, and that the key top and the guide are separately formed, with an interstice provided therebetween, thereby preventing from such a malfunction that the selection switch is also operated at the operation of the decision switch.

According to the switching device of the present invention, the decision switch and the selection switch are formed by a domed switch for switching through conducting electricity between isolated conductive terminals by the pressure on the curved protruded elastic material and the decision switch is formed by the domed switch of more layers than the selection switch, thereby preventing from such a malfunction that the decision switch also goes down when the selection switch is pressed.

The switching device of the present invention comprises a decision switch for deciding an operational instruction, a selection switch disposed around the decision switch for selecting an operational instruction, a key top whose central portion is disposed over the decision switch, and a key base disposed between the both switches (namely, the decision switch and the selection switch) and the key top, and it is constituted in that the pressure on the central portion of the key top is transmitted to the decision switch through the key base, the force of tilting the key top toward the center axis is transmitted to the selection switch through the key base, and that the selection switch and the key base are provided adjacently, while an interstice is provided between the decision switch and the key base, thereby preventing from such a malfunction that the decision switch is also operated at the operation of the selection switch.

According to the switching device of the present invention, in the above structure, a through hole is provided in the key base between the portion corresponding to the upper portion of the decision switch and the portion corresponding to the upper portion of the selection switch, so to make this portion softer than the other portions, thereby preventing from such a malfunction that the other is also operated at the operation of one of the decision switch and the selection switch.

According to the switching device of the present invention, the decision switch and the selection switch are formed on a key sheet and the same key sheet and the key base are integrally formed with the key sheet and the key base of each ten-key, thereby realizing the reduction in the number of the parts and the cost and realizing downsizing and thinning of the switching device.

What is claimed is:

1. A switching device, comprising:
a decision switch for deciding an operational instruction;
a selection switch disposed around the decision switch for selecting an operational instruction;
a key top whose central portion is disposed over the decision switch; and
a guide disposed around the key top, in which
pressure on central portion of the key top is transmitted to the decision switch and force of tilting the key top toward a center axis is transmitted to the selection switch through the guide, and
the key top and the guide are separately formed with an interstice provided between the key top and the guide.

2. A switching device, comprising:
a decision switch for deciding an operational instruction;
a selection switch disposed around the decision switch for selecting an operational instruction; and
a key top whose central portion is disposed over the decision switch, in which
pressure on central portion of the key top is transmitted to the decision switch and force of tilting the key top toward a center axis is transmitted to the selection switch,
the decision switch and the selection switch are formed by a domed switch for switching through conducting electricity between isolated conductive terminals by pressure on a curved protruded elastic material, and
the decision switch is formed by the domed switch of more layers than the selection switch.

3. A switching device, comprising:
a decision switch for deciding an operational instruction;
a selection switch disposed around the decision switch for selecting an operational instruction;
a key top whose central portion is disposed over the decision switch; and
a key base disposed between the both switches and the key top, in which
pressure on central portion of the key top is transmitted to the decision switch through the key base and force of tilting the key top toward a center axis is transmitted to the selection switch through the key base, and
the selection switch and the key base are adjacently provided, while an interstice is provided between the decision switch and the key top.

4. A switching device as claimed in claim 3, in which
portion of the key base between the portion corresponding to the upper portion of the decision switch and the portion corresponding to the upper portion of the selection switch is formed softly compared with the other portions.

5. A switching device as claimed in claim 4, in which
a through hole is provide in the key base between the portion corresponding to the upper portion of the decision switch and the portion corresponding to the upper portion of the selection switch, thereby making this portion softer than the other portion.

6. A switching device as claimed in claim 3, in which
the decision switch and the selection switch are formed on a key sheet and the key sheet and the key base are integrally formed with the key sheet and the key base of each ten-key.

7. A switching device as claimed in claim 4, in which
the decision switch and the selection switch are formed on a key sheet and the key sheet and the key base are integrally formed with the key sheet and the key base of each ten-key.

8. A switching device as claimed in claim 5, in which
the decision switch and the selection switch are formed on a key sheet and the key sheet and the key base are integrally formed with the key sheet and the key base of each ten-key.

9. A switching device as claimed in claim 1, further comprising:
a key base disposed between the both switches and the key top, in which
the pressure on the central portion of the key top is transmitted to the decision switch through the key base and the force of tilting the key top toward the center axis is transmitted to the selection switch through the key base, and
the portion of the key base between the portion corresponding to the upper portion of the decision switch and the portion corresponding to the upper portion of the selection switch is formed softly compared with the other portions.

10. A switching device as claimed in claim 9, in which
a through hole is provide in the key base between the portion corresponding to the upper portion of the decision switch and the portion corresponding to the upper portion of the selection switch, thereby making this portion softer than the other portions.

11. A switching device as claimed in claim 9, in which
the decision switch and the selection switch are formed on a key sheet and the key sheet and the key base are integrally formed with the key sheet and the key base of each ten-key.

12. A switching device as claimed in claim 10, in which
the decision switch and the selection switch are formed on a key sheet and the key sheet and the key base are integrally formed with the key sheet and the key base of each ten-key.

13. A switching device as claimed in claim 2, comprising:
a key base disposed between the both switches and the key top, in which
the pressure on the central portion of the key top is transmitted to the decision switch through the key base and the force of tilting the key top toward the center axis is transmitted to the selection switch through the key base, and
the portion of the key base between the portion corresponding to the upper portion of the decision switch and the portion corresponding to the upper portion of the selection switch is formed softly compared with the other portions.

14. A switching device as claimed in claim 13, in which
a through hole is provide in the key base between the portion corresponding to the upper portion of the decision switch and the portion corresponding to the upper portion of the selection switch, thereby making this portion softer than the other portions.

15. A switching device as claimed in claim 13, in which
the decision switch and the selection switch are formed on a key sheet and the key sheet and the key base are integrally formed with the key sheet and the key base of each ten-key.

16. A switching device as claimed in claim 14, in which
the decision switch and the selection switch are formed on a key sheet and the key sheet and the key base are integrally formed with the key sheet and the key base of each ten-key.

17. A portable terminal device having a switching device
the switching device comprising:
a decision switch for deciding an operational instruction;
a selection switch disposed around the decision switch for selecting an operational instruction;
a key top whose central portion is disposed over the decision switch; and
a guide disposed around the key top, in which
pressure on central portion of the key top is transmitted to the decision switch and force of tilting the key top toward a center axis is transmitted to the selection switch through the guide, and
the key top and the guide are separately formed with an interstice provided between the key top and the guide.

18. A portable terminal device having a switching device,
the switching device comprising:
a decision switch for deciding an operational instruction;
a selection switch disposed around the decision switch for selecting an operational instruction; and
a key top whose central portion is disposed over the decision switch, in which
pressure on central portion of the key top is transmitted to the decision switch and force of tilting the key top toward a center axis is transmitted to the selection switch,
the decision switch and the selection switch are formed by a domed switch for switching through conducting electricity between isolated conductive terminals by pressure on a curved protruded elastic material, and
the decision switch is formed by the domed switch of more layers than the selection switch.

19. A portable terminal device having a switching device,
the switching device comprising:
a decision switch for deciding an operational instruction;
a selection switch disposed around the decision switch for selecting an operational instruction;
a key top whose central portion is disposed over the decision switch; and
a key base disposed between the both switches and the key top, in which
pressure on central portion of the key top is transmitted to the decision switch through the key base and force of tilting the key top toward a center axis is transmitted to the selection switch through the key base, and
the selection switch and the key base are adjacently provided, while an interstice is provided between the decision switch and the key base.

20. A switching device as claimed in claim 1, in which
four selection switches are disposed around the decision switch at regular intervals in a shape of a cross,
a cylindrical boss with the same center axis as that of the key top is formed at the central portion of the key top in a way of protruding toward the decision switch,
the central portion of the guide is disposed at the upper portion opposite to the central portion of the decision switch, with four ribs extended therefrom toward the respective selection switches in a shape of a cross and a cylindrical hole for putting through the boss of the key top formed there,
with a key base disposed between the both switches and the key top, the pressure on the central portion of the key top is transmitted to the decision switch through the key base and the force of tilting the key top toward the center axis is transmitted to the selection switch through the key base,
the four ribs of the guide are integrally fixed to the key base at the upper portions opposite to the central portions of the respective selection switches and a concave/convex portion for mutually positioning the guide and the key base is formed in one part of the four fixed positions,
an end portion of the boss of the key top is integrally fixed to the key base and a concave/convex portion for mutually positioning the key top and the key base and mutually stopping rotation is formed at this fixed portion,
the decision switch and the selection switch are formed by a domed switch for switching through conducting electricity between isolated conductive terminals by pressure on a curved protruded elastic material and the decision switch is formed by the domed switch of more layers than the selection switch,
the selection switch and the key base are adjacently provided, while an interstice is provided between the decision switch and the key base,
a through hole is provide in the key base between the portion corresponding to the upper portion of the decision switch and the portion corresponding to the upper portion of the selection switch, thereby making this portion softer than the other portions, and
the decision switch and the selection switch are formed on a key sheet and the key sheet and the key base are integrally formed with the key sheet and the key base of each ten-key.

21. A switching device, comprising:
a decision switch for deciding an operational instruction;
a selection switch disposed around the decision switch for selecting an operational instruction;
a key top whose central portion is disposed over the decision switch; and
a guide disposed around the key top, in which
pressure on central portion of the key top is transmitted to the decision switch and force of tilting the key top toward a center axis is transmitted to the selection switch through the guide, and
the key top and the guide are formed separately and adjacently in a slidable way.
